(19) United States
(12) Patent Application Publication
(10) Pub. No.: US 2002/0159712 A1
(43) Pub. Date: Oct. 31, 2002

(54) EMI shield for fiber optic adapter

(76) Inventor: Marlon E. Holmquist, Gibbon, MN (US)

Correspondence Address: MERCHANT & GOULD PC, P.O. BOX 2903, MINNEAPOLIS, MN, 55402-0903, US

(21) Appl. No.: 09/845,038

(22) Filed: Apr. 27, 2001

(51) Int. Cl. G02B 6/38; G02B 6/36

(52) U.S. Cl. 385/70; 385/53

(57) ABSTRACT

A fiber optic adapter includes first and second adapter portions each for receiving a fiber optic connector. The first and second adapter portions each define an axial opening, wherein the axial openings are aligned. An electrically conductive shield is positioned between the first and second adapter portions. An electrical link is provided between the electrically conductive shield and a conductive portion of a bulkhead receiving the adapter.

### FIELD OF THE INVENTION

The present invention relates to fiber optic adapters and connectors. More particularly, the present invention relates to an electrical protection feature for fiber optic equipment including fiber optic adapters.

### BACKGROUND OF THE INVENTION

Fiber optic connectors and mating adapters are often used with sensitive telecommunications transmission equipment. For example, equipment which converts signals between fiber optic signals and electrical signals may be sensitive to electromagnetic interference (EMI) or other electrical interference. Therefore, there is a need to protect the equipment from external sources of electrical interference. One source of entry of interference is through openings into the equipment at the interface where the fiber optic connectors mount to the mating adapters. There is a need for shielding equipment from electrical interference at the fiber optic connector and adapter access locations. There is also a need to shield electrical energy from escaping from the equipment, in some situations.

### SUMMARY OF THE INVENTION

The present invention includes an adapter having first and second adapter portions, where each adapter portion receives a connector in an axial opening for alignment of the two connectors. The adapter is mountable to a bulkhead or frame. An electrically conductive shield is positioned between the first and second adapter portions. The shield includes an electrical link for linking the shield to the bulkhead or frame to ground the shield. The shield includes a generally planar portion positioned between the mated first and second adapter portions wherein the planar portion is perpendicular to the adapter axis.

A further aspect of the present invention relates to a method of assembly wherein first and second fiber optic adapter portions made from non-conductive materials, such as plastic, are provided. The method further includes placing a conductive shield between the first and second adapter portions, and further mounting the first and second adapter portions to one another to form the adapter.

A further method in accordance with the present invention includes providing a fiber optic adapter with an intermediate electrically conductive shield positioned between first and second opposed ends, mounting the adapter to a conductive bulkhead, and mounting an electrical link between the bulkhead and the intermediate shield.

### BRIEF DESCRIPTION OF THE DRAWINGS

FIG. 1 is a first perspective view of a first preferred embodiment of a fiber optic adapter in accordance with the present invention;

FIG. 2 is a second perspective view of the fiber optic adapter of FIG. 1;

FIG. 3 is an exploded perspective view of the fiber optic adapter shown in FIG. 1;

FIG. 4 is an exploded perspective view of the fiber optic adapter shown in FIG. 2;

FIG. 5 is a front view of the conductive shield;

FIG. 6 is a front view of the bulkhead sized for receipt of the adapter of FIGS. 1-4, and showing the adapter and the conductive shield in dashed lines;

FIG. 7 is an exploded perspective view of a second preferred embodiment of a fiber optic adapter in accordance with the present invention;

FIG. 8 is a cross-sectional view along the adapter axis of the fiber optic adapter of FIG. 7.

### DETAILED DESCRIPTION OF THE PREFERRED EMBODIMENTS

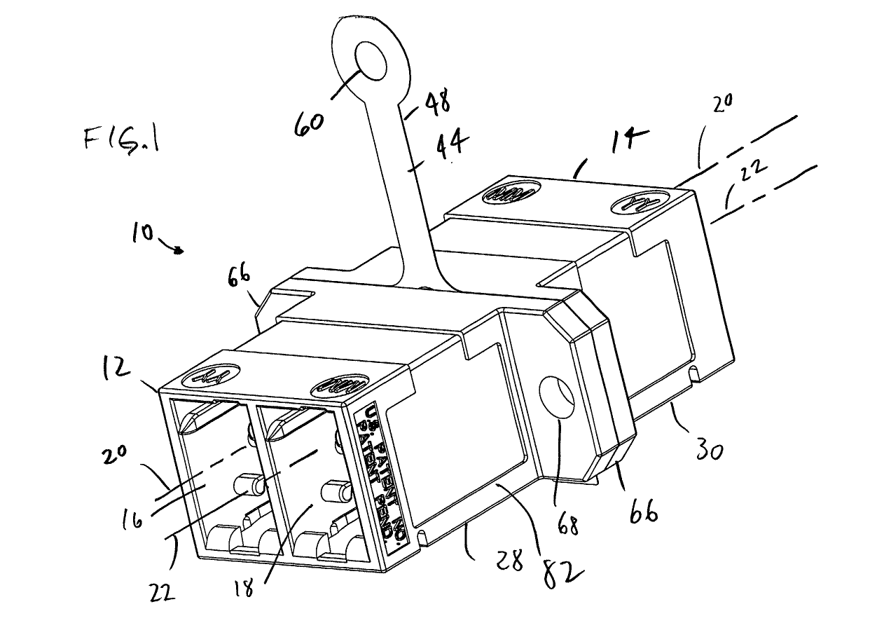

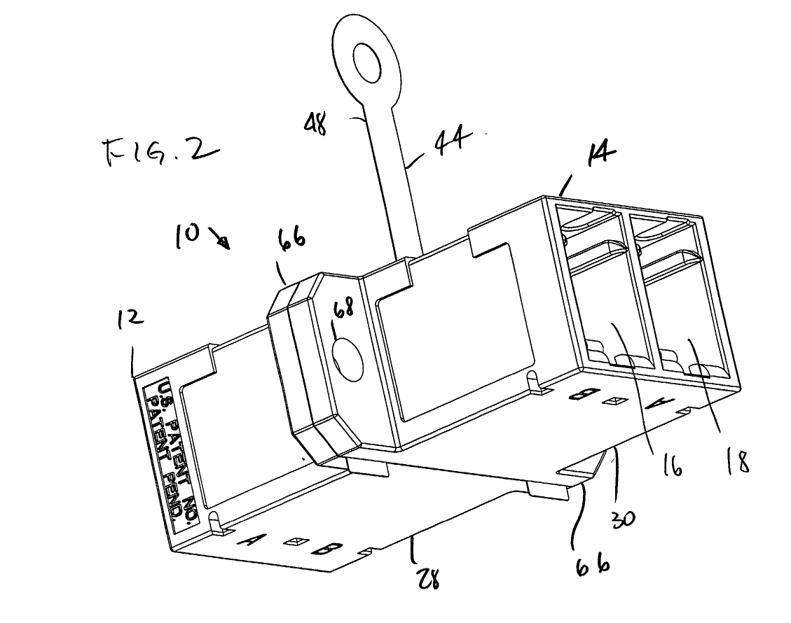

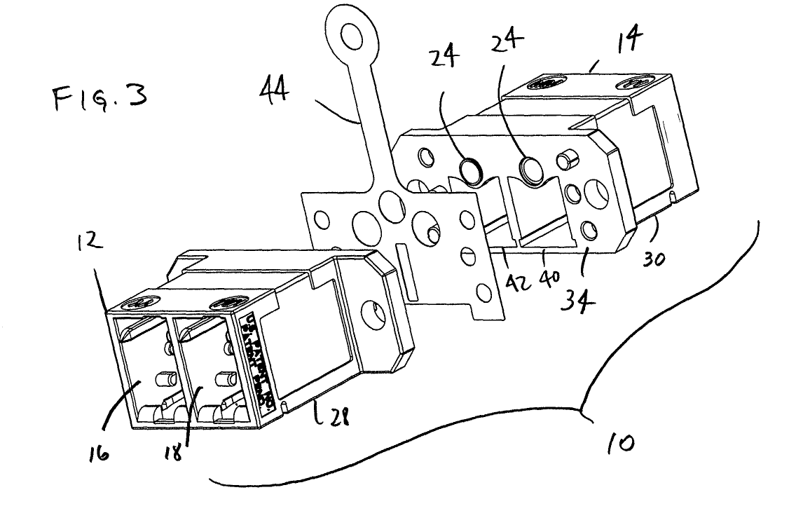

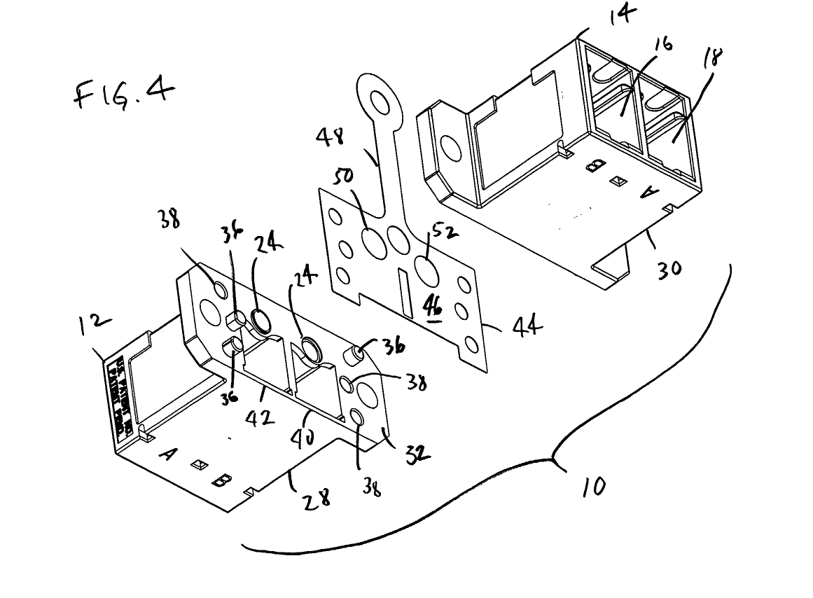

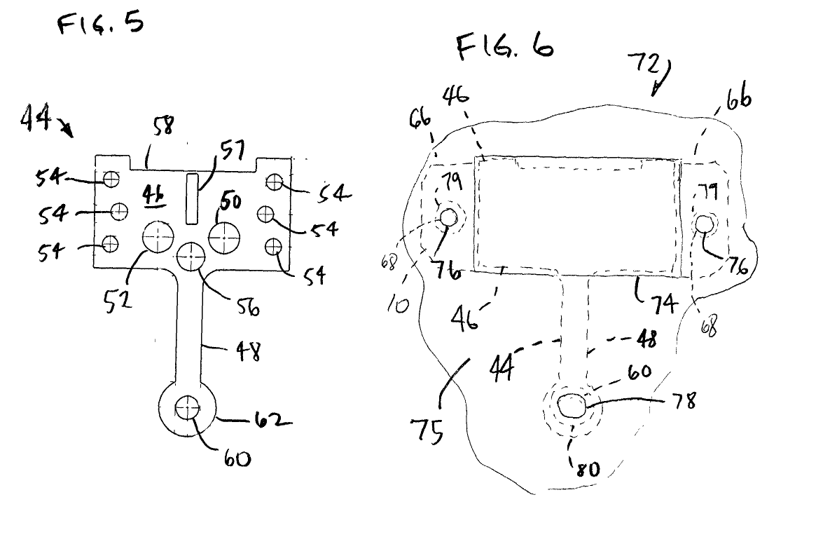

Referring now to FIGS. 1-6, a first preferred embodiment of a fiber optic adapter 10 is shown. Adapter 10 includes first and second ends 12, 14 where each end 12, 14 defines an open end. Adapter 10 defines two connector chambers 16, 18 at each open end. Adapter 10 further defines two adapter axes 20, 22. Disposed within each chamber 16, 18 is a ferrule opening 24 for receipt of an end of a ferrule of a fiber optic connector inserted into one of chambers 16, 18 along one of adapter axes 20, 22. Adapter 10 receives four connectors for making two separate fiber optic connections.

Adapter 10 includes first and second adapter portions 28, 30 mated at faces 32, 34. In the preferred embodiment, adapter portions 28, 30 are identical. Preferably, adapter portions 28, 30 are made from non-conductive material, such as molded plastic. To facilitate assembly, faces 32, 34 include posts 36, and recesses 38 for receiving posts 36 of the opposite adapter portion.

Adapter portions 28, 30 further include openings 40, 42 exposed at faces 32, 34. Disposed between adapter portions 28, 30 is a conductive shield 44. Shield 44 covers openings 40, 42, and other portions of the mated faces 32, 34. Shield 44 includes a major planar portion 46 and a conductive lead or strap 48 extending away. Planar portion 46 includes first and second connector openings 50, 52 each for alignment with one of ferrule openings 24. Shield 44 thereby does not block the fiber optic connection between two axially aligned connectors. Planar portion 46 is positioned to face the same direction as axes 20, 22.

In the preferred embodiment of FIGS. 1-6, planar portion 46 further includes openings 54 for posts 36. Adhesive can be used to hold portions 28, 30 together with shield 44 positioned therebetween. Further openings 56, 57 can be provided for permitting adhesive to link adapter portions 28, 30 directly. A slot 58 can also be provided for further direct contact for the adhesive between adapter portions 28, 30.

Strap 48 includes an aperture 60 at distal end 62. Aperture 60 is sized for receipt of a fastener to link shield 44 to ground during use, as will be described in further detail below. Shield 44 is made from metal in the preferred embodiment, such as copper or copper and nickel. Strap 48 is an extension of planar portion 46 in the preferred embodiment. The thickness of shield 44 can be varied for different shielding characteristics.

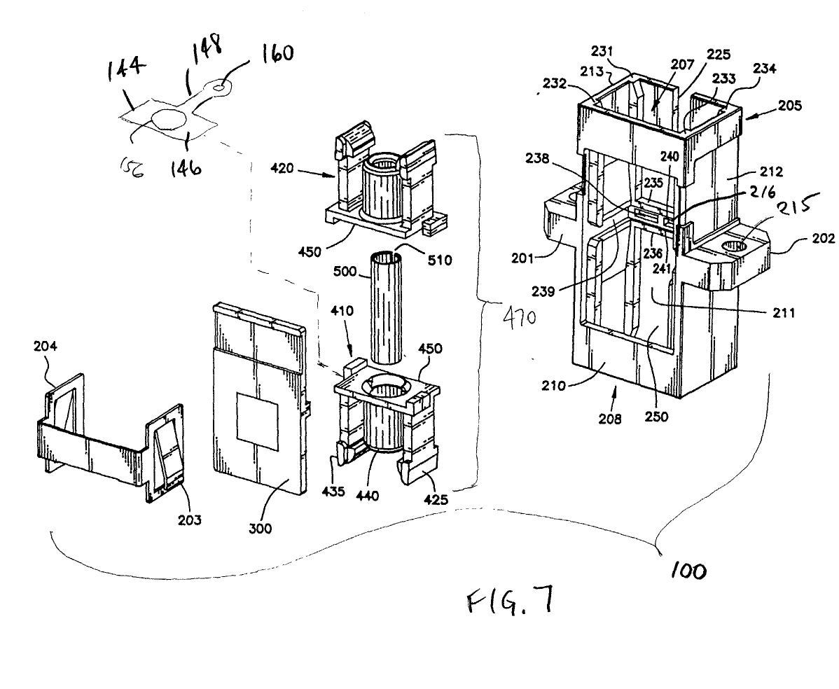

An exterior of adapter 10 includes tabs or flanges 66, each defining an aperture 68 such as for receipt of a fastener to mount adapter 10 to a bulkhead or frame. Referring now to FIG. 6, an example bulkhead 72 is shown including a conductive plate 75 with an adapter opening 74, and fastener openings 76 for receipt of fasteners 79 through flanges 66. A further fastener opening 78 is provided for receipt of a fastener 80 through aperture 60 of strap 48. Bulkhead 72 includes or is made of a conductive material which allows grounding of shield 44. One example bulkhead 72 is made from sheet metal. Further details of adapter 10 relating to the connector mating features, including the internal structures, and example mating connectors themselves are shown and described in U.S. Pat. No. 6,142,676, the disclosure of which is incorporated by reference. U.S. Pat. No. 6,142,676 shows an alternative mounting clip positioned in area 82 of adapter 10 for mounting adapter 10 to the bulkhead instead of with fasteners 79.

As can be seen with reference to FIG. 6, the outer periphery of major planar portion 46 covers substantially all of opening 74 through bulkhead 72 to reduce EMI passing through bulkhead. Bulkhead 72 is part of an enclosure or other equipment containing components which are desired to be shielded from electrical interference, either external, internal or both to the enclosure.

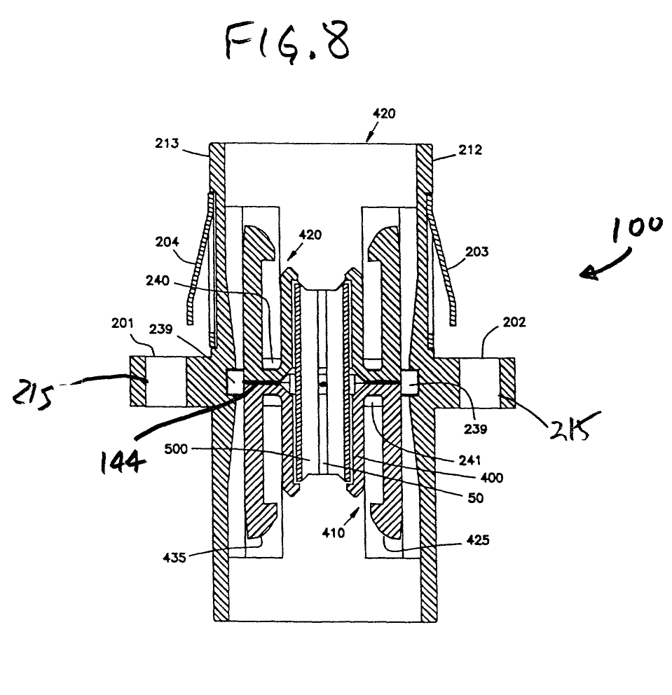

Now with reference to FIGS. 7 and 8, a second preferred embodiment of an adapter 100 is shown. Adapter 100 is sized for receiving one connector on each end, to make the fiber optic connection. Adapter 100 includes a main body 205 and an access plate or cover 300. Main body 205 has an axial cavity defined by top sidewall 210, bottom sidewall 211, right sidewall 212, and left sidewall 213. The axial cavity of main body 205 extends between a first opening 207 and a second opening 208. Located on the exterior of main body 205 are a pair of flanges or tabs 201, 202. One flange is on right sidewall 212 and one flange is on left sidewall 213. Flanges 201, 202 are operative in supporting adapter 100 on a planar surface. To lock adapter 100 into place on a planar surface, such as bulkhead 72, fasteners are received through holes 215. Alternatively, there is further provided a pair of outside retaining clips 203, 204, one clip associated with each flange 201, 202 respectively. When the adapter is in place on a planar surface, the surface abuts with one tab on one side and an outer retaining clip on its other side, thereby holding it in place.

The inner cavity of main body 205 contains a plurality of ridges and grooves used to hold an inner housing 470 in place which in turn is used to hold the ferrules of two fiber optic connectors received in the ends of adapter 100. The inner cavity includes longitudinal ridges 231, 232, 233 and 234. Transverse ridges 235, 236 are located on the inner surface of bottom sidewall 211. Ridges 235, 236 are generally perpendicular to the axial cavity of main body 205. Parallel ridges 235, 236 define groove 238 which is perpendicular to the axial cavity of main body 205. Ridges 235, 236 on bottom sidewall 211 are connected by ridges 240, 241. The width of groove 238 is equal to the thickness of combined flanges 450 of inner housing 470, with a conductive shield 144 disposed therebetween. The right sidewall 212 and the left sidewall 213 each have a groove 239 that is planar with groove 238.

Located on the top sidewall 210 is an access opening 310 which allows inner housing halves 410, 420 to be inserted into the axial cavity of main body 205 and also allows main body 205 to be constructed by injection molding. Inner housing halves 410, 420 are identical. Each half includes a cylinder 440 and at one end of cylinder 440 is flange 450. Flange 450 is generally rectangular in shape. Two halves 410, 420 are connected at their respective flanges 450 respectively so as to define a common cylinder. The two flanges 450 and shield 144 define a thickness which is generally equal to that of grooves 238, 239. Attached to each flange of the inner housing halves are a pair of retaining clips 425, 435. Each retaining clip extends away from each flange parallel to cylinder 440. Located in the common cylinder is a split sleeve 500 generally cylindrical in shape, with a split, or slot 510 running the length of the cylinder. Split sleeve 500 is generally constructed of copper and its dimensions are well known in the art. It is the common cylinder defined by inner halves 410, 420 where ferrules of two different fiber optic connectors meet and are in optical communication. In a preferred embodiment, access panel 300 covers access opening 250. Ridges 232, 233 that extend along the corners of the inner surface of main body 205 define two shelf surfaces one on left sidewall 213 and one on right sidewall 212 that the access cover can rest on. The access cover can then be ultrasonically welded to the shelf so that it is permanently in place.

Adapter 100 further includes a conductive shield 144 positioned between adapter portions 410, 420. In a similar manner as above with respect to adapter 10, shield 144 includes a strap 148 with a fastener hole 160 for linking planar portion 146 to ground, such as the conductive bulkhead surface. Bottom sidewall 211 includes a hole 216 for passage of strap 148. Planar portion 146 includes a central hole 156 for the fiber optic connection.

Adapter 100 can be received in adapter opening 74 of bulkhead 72 of FIG. 6. Clips 203, 204 cooperate with flanges 201, 202 to mount adapter 100 to opening 74. Adapter 100 and the mating connectors may sometimes be referred to as SC-type adapter and connectors, a term frequently used in the fiber optic connector industry. Further details of the interior structures of adapter 100 and the mating connectors are shown and described in U.S. Pat. No. 5,317,663, the disclosure of which is hereby incorporated by reference.

Other electrical ground links could be used besides straps 48, 148. Conductive tapes or adhesives could be used. Shields 44, 144 could be provided with extensions that are biased into electrical contact with the bulkhead opening 74 during insertion of adapters 10, 100.

Adapters 10, 100 are two examples of EMI shielded adapters. Other adapter styles can also be provided with EMI protection by positioning a shield between mating elements of the adapter and providing an electrical link to the shield for grounding purposes.

With regard to the foregoing description, it is to be understood that changes may be made in detail, especially in matters of the shape, size and arrangement of the parts without departing from the scope of the present invention. It is intended that the specification and depicted aspects be considered exemplary only, with a true scope and spirit of the invention being indicated by the broad meaning of the following claims.

What is claimed is:

1. A fiber optic adapter comprising:
a first adapter portion for receiving a first connector and defining an axial opening for an end of the first connector;
a second adapter portion for receiving a second connector and defining an axial opening for an end of the second connector, the axial opening of the first adapter portion aligned with the axial opening of the second adapter portion;
an electrically conductive shield positioned between the first and second adapter portions;
means for mounting the adapter to a bulkhead;
means for electrically linking the shield to a conductive portion of the bulkhead.

2. The adapter of claim 1, wherein the shield includes a planar portion extending transversely to the axial openings.

3. The adapter of claim 1, wherein the means for mounting includes a clip.

4. The adapter of claim 1, wherein the means for mounting includes two flanges.

5. The adapter of claim, 1, wherein the means for electrically linking includes a strap of electrically conductive material extending from the shield.

6. A fiber optic adapter comprising:
a first adapter portion for receiving a first connector and defining an axial opening for an end of the first connector;
a second adapter portion for receiving a second connector and defining an axial opening for an end of the second connector, the axial opening of the first adapter portion aligned with the axial opening of the second adapter portion;
an electrically conductive shield positioned between the first and second adapter portions, wherein the shield includes a planar portion extending transversely to the axial openings, wherein the shield includes an opening aligned with the axial openings.

7. The adapter of claim 6, further comprising a strap extending from the shield.

8. A method of assembly of a fiber optic adapter comprising the steps of:
providing first and second adapter portions, each adapter portion sized for mating with a fiber optic connector;
placing a conductive shield between the first and second adapter portions;
mounting the first and second adapter portions together with the conductive shield disposed therebetween.

9. A method of assembly of a fiber optic system comprising the steps of:
providing a fiber optic adapter with an intermediate conductive shield positioned between first and second ends of the fiber optic adapter, each end of the fiber optic adapter sized for mating with a fiber optic connector;
mounting the adapter to a bulkhead;
mounting an electrically conductive strap to the intermediate shield and to a conductive portion of the bulkhead.
